(19) United States
(12) Patent Application Publication
(10) Pub. No.: US 2009/0023021 A1
(43) Pub. Date: Jan. 22, 2009

(54) Fuel Cell Apparatus And Electronic Appliances Mounting The Same

(76) Inventors: Yasuaki NORIMATSU, Hitachi (JP); Akihiko KANOUDA, Hitachinaka (JP); Noboru AKIYAMA, Hitachinaka (JP); Mutsumi KIKUCHI, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/233,788

(22) Filed: Sep. 19, 2008

Related U.S. Application Data
(63) Continuation of application No. 10/920,436, filed on Aug. 18, 2004, now abandoned.

(30) Foreign Application Priority Data
Oct. 23, 2003 (JP) 2003-362682
Nov. 6, 2003 (JP) 2003-376368
Jan. 20, 2004 (JP) 2004-011289

(51) Int. Cl. H01M 8/06

(52) U.S. Cl. 429/19; 429/34

(57) ABSTRACT

In order to provide a fuel cell apparatus with an effective energy consumption by selecting a suitable fuel cartridge mounted on the apparatus, the present invention provides a fuel cell apparatus comprising at least two fuel storage sections for storing fuel for power generation, wherein at least one of the storage sections is selected and used, while the fuel cell is in service.

### CLAIM OF PRIORITY

This application is a continuation application of U.S. application Ser. No. 10/920,436, filed Aug. 18, 2004, the contents of which are incorporated herein by reference.

The present application claims from Japanese application serial No. 2003-362682, filed on Oct. 23, 2003; No. 2003-376368, filed on Nov. 6, 2003; and No. 2004-11289, filed on Jan. 20, 2004, the contents of which are hereby incorporated by reference into the present application.

### FIELD OF THE INVENTION

The present invention relates to a fuel cell apparatus and electronic appliances mounting the same.

### BACKGROUND OF THE INVENTION

In recent years, portable electronic instruments such as portable telephones, notebook type personal computers, audio/visual devices, mobile terminals, etc. have been populated rapidly.

As power sources for the portable electronic appliances, fuel cells have been studied. Since the fuel cells directly convert chemical energy that fuel has into electrical energy in a electrochemical manner, there is no need of power driven devices such as engine generators in internal combustion engines. Thus, the fuel cells are promising as small size generating devices. Further, since the fuel cells can continue generation of electricity as long as fuel is supplied, it is unnecessary to stop the operation of devices for charging the conventional secondary batteries. As the fuel cells of this type, reformers are equipped for producing hydrogen fuel. The fuel cells of this type are operated at around 80° C. or higher, but there are fuel cells that are operated at around room temperature. One example of the room temperature operation type fuel cells is methanol direct fuel cells (DMFC), which directly oxidize methanol at a fuel electrode.

In the conventional secondary batteries, many of the batteries have a function that informs users of residual energy of the batteries by suitable manner such as displays or alarms. The changing of electromotive force residual energy based on a discharge amount can be detected. However, in the fuel cells, output characteristics do not appear unless changes such as fuel concentration filled in the power generation section occur.

The voltage drop continues until fuel is used up. Accordingly, it is a subject of a fuel cell to supply an effective electric power to a load by means of detection of a residual amount of fuel or by a stable fuel supply to the load. As a method for supplying fuel to the fuel cells, a fuel pack is filled with fuel. A water recovery envelope is disposed in the fuel pack.

As the pressure in the pack increases by an increase in an amount of a by-product produced by use of the fuel cells, the fuel is supplied by the action of the pressure of the envelope. As a result, the fuel can be supplied almost completely. This fuel cell is disclosed in Japanese patent Laid-open 2003-36879.

### DESCRIPTION OF THE INVENTION

If the fuel cells are used for the portable appliances, downsized, light-weighted appliances with high reliability will be provided. The present invention aims at providing a fuel cell apparatus can be used in any directions without causing malfunction like the conventional secondary batteries. The fuel cell apparatus has a hot-swap function by which an empty fuel cartridge after using it can be exchanged with another one, keeping the appliances in service.

The present invention provides a fuel cell apparatus having at least two fuel storage sections for storing fuel that supplies electric power to a load, wherein at least one of the fuel storage sections is selectively used.

### BRIEF DESCRIPTION OF DRAWINGS

FIG. 1 is a perspective view of a fuel cell apparatus to which a load is mounted.

FIG. 2 is a blockdiagram showing the fuel cell apparatus according to an example of the present invention.

FIG. 3 is a flow chart showing a fuel selection process.

FIG. 4 is a partially broken-away perspective view of a cylinder of a fuel cartridge according to an example of the present invention.

FIG. 5 is a cross sectional view of the cartridge of an example according to the present invention, wherein the change of a fuel residual amount is shown. FIG. 5 (a) shows that a residual amount of fuel is large, and FIG. 5 (b) shows the residual amount of fuel is small.

FIG. 6 is a cross sectional view of a fuel cartridge, of an example according to the present invention, having a conductive terminal with changing detection sensitivity.

FIG. 7 is a cross sectional view of a fuel cartridge, of an example according to the present invention, having a function of zero detection.

FIG. 8 is a cross sectional view of a fuel cartridge according to the present invention to which a screw mechanism is attached.

FIG. 9 is a cross sectional view of a fuel cartridge according to the present invention to which a leak prevention cap is disposed.

FIG. 10 is a circuit diagram of a DC/DC converter to which a high voltage prevention resister is attached.

FIG. 11 is a DC/DC converter circuit that uses a resister of the fuel cartridge for detection of a residual amount of fuel as the high voltage prevention resister.

FIG. 12 is a cross sectional view of a fuel selection means using a step motor, according to the present invention.

FIG. 13 is a cross sectional view of a fuel tank which is capable of re-filing.

FIG. 14 is a partial cross sectional view of an apparatus to which a fuel tank and a charger are connected.

FIG. 15 is a blockdiagram showing a fuel cell apparatus, according to the present invention, provided with a charger.

FIG. 16 is a blockdiagram of a fuel cell apparatus, according to the present invention.

FIG. 17 is a flow chart showing a fuel usage status selection of an example according to the present invention.

FIG. 18 is a cross sectional view of a fuel cartridge of another example according to the present invention.

FIG. 19a is a partially broken away perspective view of a fuel cartridge of an example according to the present invention.

FIG. 19b is a cross sectional view of the fuel cartridge shown in FIG. 19a.

FIG. 19c is a cross sectional view along the line B-B in FIG. 19b.

FIG. 20 is a blockdiagram of a fuel cell apparatus of an example according to the present invention.

FIG. 21 is a flow chart showing fuel selection of an example according to the present invention.

FIG. 22 is a blockdiagram of a fuel cell apparatus according to the present invention.

FIG. 23 is a flow chart showing fuel usage selection process of an example according to the present invention.

FIG. 24 is a perspective view of a car type fuel cartridge of an example according to the present invention.

FIG. 25 is a cross sectional view of a fuel cartridge of an example according to the present invention.

FIG. 26 is a perspective view of a cylinder used in a fuel cartridge of an example according to the present invention.

### PREFERRED EMBODIMENTS OF THE INVENTION

In the following, embodiments of the fuel cell apparatuses according to the present invention will be explained by reference to drawings.

### Embodiment 1

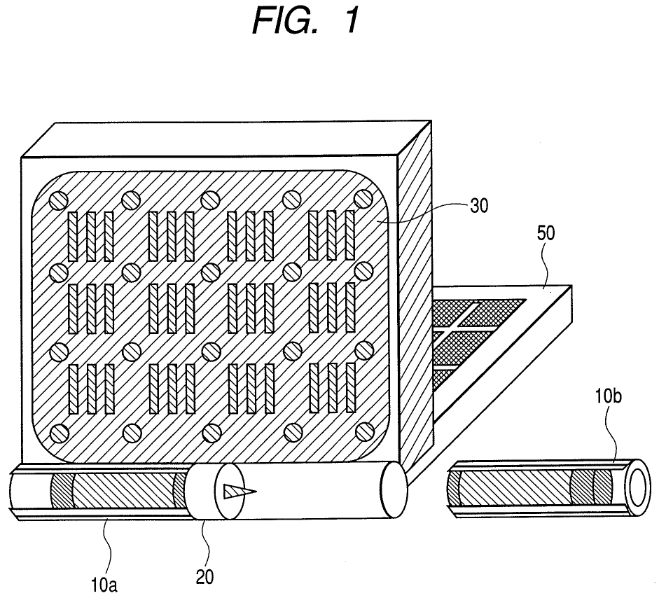

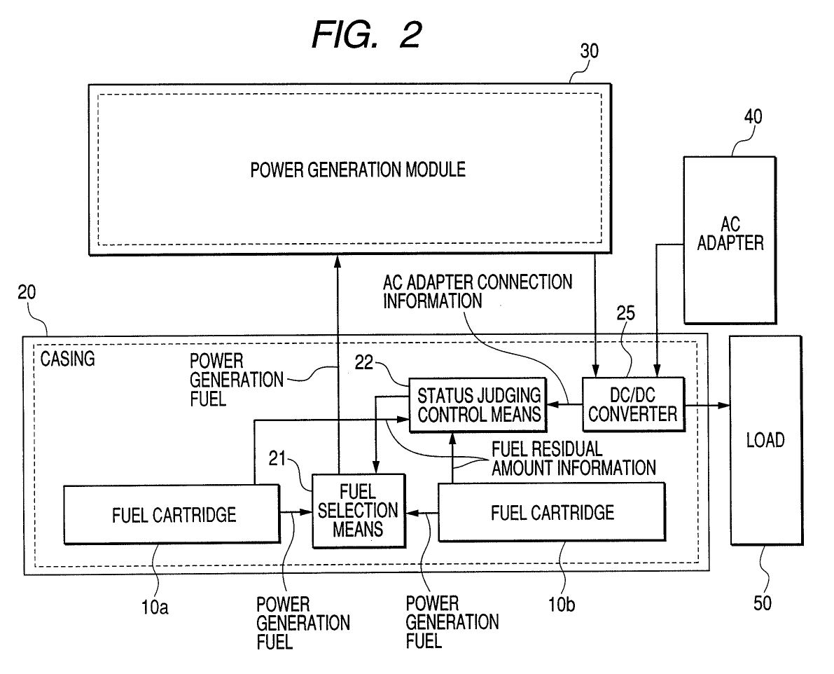

FIG. 1 shows an appearance of the fuel cell apparatus to which a load is connected. FIG. 2 is a blockdiagram of the fuel cell apparatus according to the present invention. In this example, disposable fuel cartridges 10a, 10b may be used as fuel storage sections. The cartridges are not refilled. Users can confirm that the cartridges are empty, and they can exchange them with new ones. The fuel cell is a direct methanol fuel cell, i.e. MDFC that uses methanol as fuel. In case of panel type fuel cell apparatuses, fuel supply means such as suction means using capillary action or a pump is disposed. In case of stacking type fuel cell apparatus, a pump is used for fuel supply at the anode and a fan or blower is used for air supply at the cathode. This example may employ the above structures.

The fuel cell apparatus in this example comprises two fuel cartridges 10a, 10b, fuel cartridge selecting means 21, DC/DC converter 25, fuel storage section 20 having status judging means 22, and a power generation module 30. The fuel cartridges 10a, 10b, the fuel storage section 20 and the power generation module 30 are detachable from the apparatus. By this structure, exchange of parts or elements and disassemble and division of the apparatus for re-cycling are easy. The DC/DC converter has a primary battery, secondary battery, capacitor, etc. for starting the apparatus. As a load 50, small size electronic appliances such as a digital video camera, digital still camera, PDA, portable telephones are used instead of the notebook type personal computer shown in FIG. 1.

The fuel cartridge selection means 21 that is used, based on situations is explained in detail in the following.

The fuel cartridge selection means 21 has four usage modes. A first mode uses fuel from both of the fuel cartridges 10a, 10b. A second mode uses fuel only from the cartridge 10a. A third mode uses fuel uses fuel only from the cartridge 10b. A fourth mode does not use fuel from the cartridges 10a, 10b.

Since the first mode supplies fuel from both of the cartridges 10a, 10b to the power generation module, power supply from the power generation module 30 can start quickly. Particularly, this mode is employed at the time of start up of the fuel cell apparatus so as to quickly supply fuel to the power generation module 30.

The second mode and third mode selectively use fuel. In selecting fuel, the residual amount of fuel in the cartridges 10a, 10b is detected, and detection of dismounting the fuel cartridges is used at the same time.

When the cartridges 10a, 10b are mounted, one of the cartridges whose residual amount of fuel is smaller than in the other is used in accordance with the detection of the residual amount. When the residual amount of fuel in the cartridges is same, one of them is used. By this selection, it is possible to avoid that fuel in both of the cartridges 10a, 10b is used up simultaneously. In replacing the cartridge whose fuel is used up, the cartridge which has fuel is replaced with another one (hot swap) without stopping the load. During the replacement of the cartridges, it is unnecessary to charge buffer fuel or attach a primary battery or secondary battery for driving the load 50. Thus, it is further possible to downsize the apparatus.

In the fourth mode, fuel is not used in cases where the load 50 is shutdown or an AC adapter 40 is connected to the apparatus. Since the output from the DC/DC converter 25 is smaller than a certain value, shutdown or stand-by of the load 50 is detected, the fuel supply is cut off so that fuel consumption by fuel permeation such as cross-over in the power generation module 30 is minimized. Further, the fuel supply mode for re-start up of the load 50 can be set to the fourth mode. Similarly, when the AC adapter 40 is connected, the connection of the AC adapter 40 is detected and fuel from the cartridge 10 is stopped, thereby to minimize the fuel consumption due to the fuel permeation such as cross-over.

When the two cartridges 10a, 10b are not mounted or the residual amount of fuel in both of the cartridges is zero, the fourth mode is employed.

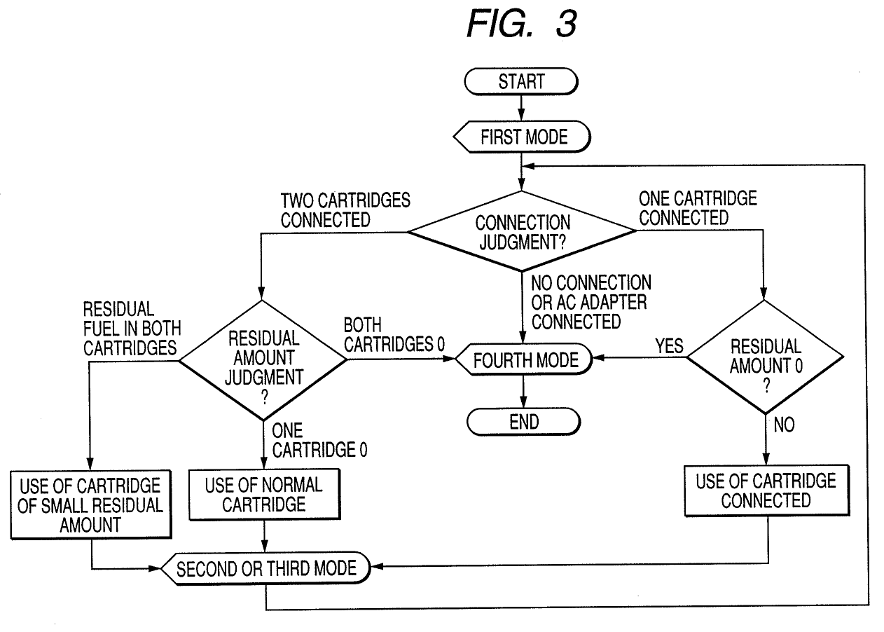

A flow chart for selectively use the four modes is shown in FIG. 3. As shown in FIG. 3, the two fuel cartridges 10a, 10b and the AC adapter 40 are selectively used in accordance with the connection conditions; when the residual amount of fuel in one of the cartridges becomes almost zero, the cartridge is changed to another one. Thus, energy is used more effectively.

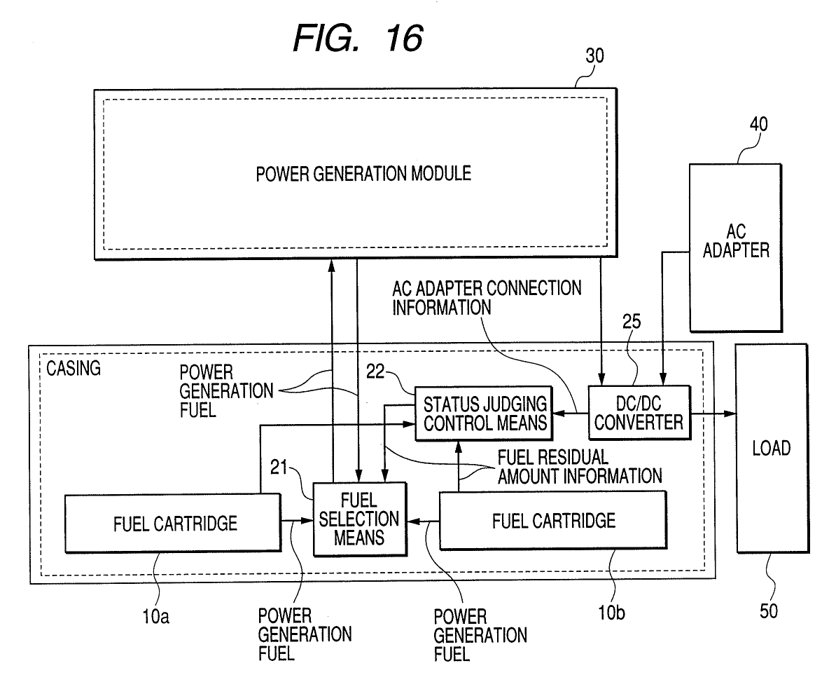

In addition to the above-described operation, a fuel returning circulation from the power generation module 30 is added to the apparatus. The fuel circulation is explained by reference to FIG. 16 in the following.

The fuel selection means 21 has five modes for fuel usage. A first mode uses fuel in both of the cartridges 10, 10b; a second mode uses fuel only in the cartridge 10a; a third mode uses fuel only in the cartridge 10b; a fourth mode does not use fuel in any of the cartridges 10, 10b and fuel returned from the power generation section; and a fifth mode uses fuel only that is returned from the power generation section for circulating fuel.

The first mode through the fourth mode are the same as those described above.

The fifth mode circulates residual fuel in the cartridges after the fuel is supplied to the power generation module and the fuel storage section. In case of the panel type fuel cell apparatus, if output of power generation is small and hence addition of fuel is not needed, circulation of fuel prevents local concentration imbalance and fill-up of the apparatus by carbon dioxide. In case of stacking type fuel cells, since fuel must be supplied continuously to the power generation module 30, the second mode, third mode and fifth mode are properly switched to supply new fuel from the cartridges or fuel returned from the power generation module, thereby to supply fuel continuously. It is possible to share the second mode, third mode and fifth mode, without completely separating them from each other.

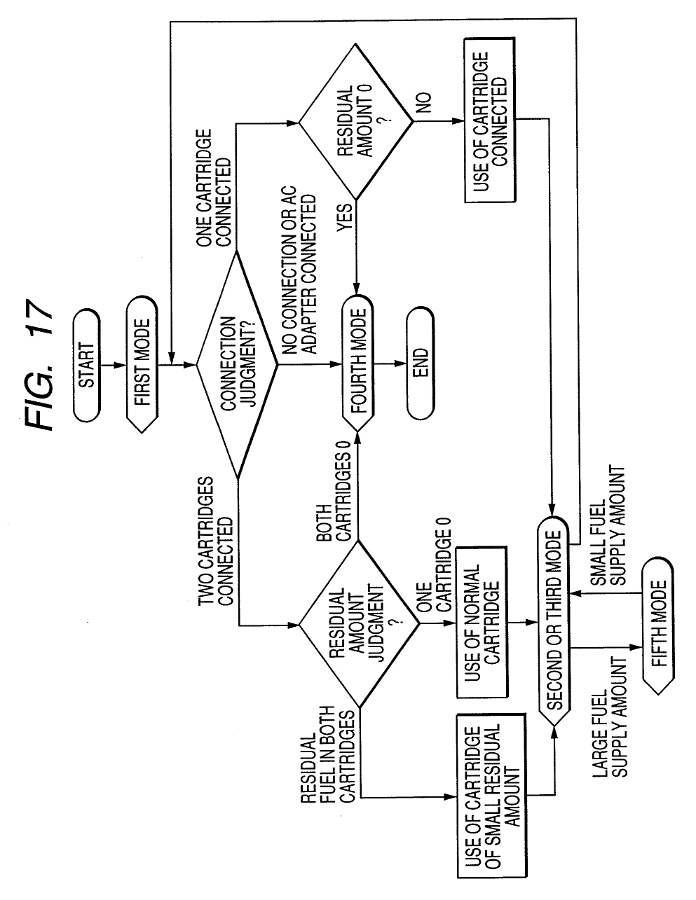

A flow chart for separately use of the five modes is shown in FIG. 17. As shown in FIG. 17, the modes are selectively used in accordance with connection of the two cartridges 10a, 10b, fuel circulation and AC adapter 40. As a result, it is possible to use energy more effectively.

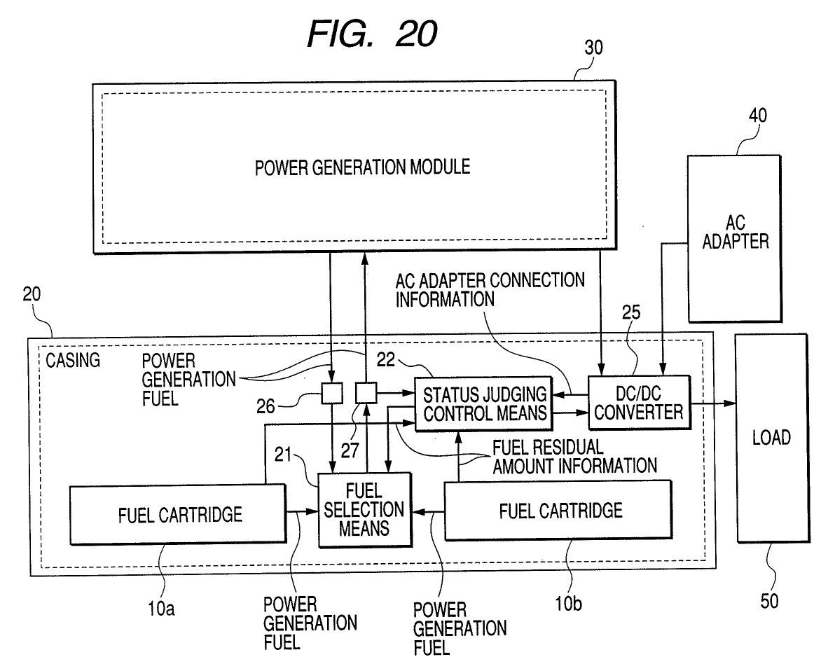

In addition to the two fuel cartridges, an inner tank 26, which stores fuel returned from the fuel cell and a fuel supply means 27 are disposed to the apparatus, which is shown in FIG. 20.

In FIG. 20, zero detection of residual fuel in the cartridges 10a, 10b or in the inner tank 26 is done in accordance with operation information from the fuel supply means 27. In case where a pump using the DC motor, for example, the status judging means 22 judges that conditions of the pump are in idle running by intake of gases such as carbon dioxide, air, etc. or in a stop which prevents supply of fuel in accordance with signals from the encoder. A flow sensor can be used in place of the encoder.

The fuel selection means 21 has the five fuel usage modes. The first mode uses fuel from both of the cartridges 10a, 10b; the second mode uses fuel only from the cartridge 10a; the third mode uses fuel only from the cartridge 10b; the fourth mode does not use fuel from the cartridges 10a, 10b and from the power generation module 30, the inner tank 28 of the power generation module being located in the fuel return passage; and the fifth mode circulate fuel using the inner tank 26 located in the fuel return passage of the power generation module 30.

The fifth mode circulates fuel remained in the inner tank 26 after fuel is supplied to the fuel storage section 20 and the power generation module 30 from the cartridge 10a or 10b. Zero detection of fuel in the inner tank 26 is easily judged in accordance with operation information from the fuel supply means 27. If the inner tank 26 is almost empty, which leads to idle running because of gases such as carbon dioxide or air is supplied to the fuel supply means 27, malfunction of the apparatus such as fuel supply shutdown is avoided because the passage is switched to the fuel cartridge to supply compressed fuel to the fuel supply means 27. In case of the panel type fuel cell apparatus, local concentration imbalance or fill-up of carbon dioxide in the apparatus is avoided by circulating fuel, when additional fuel is not needed because the output of the power generation module is small.

In case of the stacking type, which always needs a continuous supply of fuel to the power generation module 30, selection of the second mode, the third mode and the fifth mode switches new fuel from the cartridges and fuel returned from the power generation module so as to always supply fuel. Further, it is possible to use two fuel passages, without completely separating the second mode, the third mode or the fifth mode.

Even when the residual amount of fuel in both of the cartridges is zero, it is possible to continue to drive the load 50 such as a notebook type personal computer until data is saved, by waiting that the residual amount of fuel in the inner tank becomes zero.

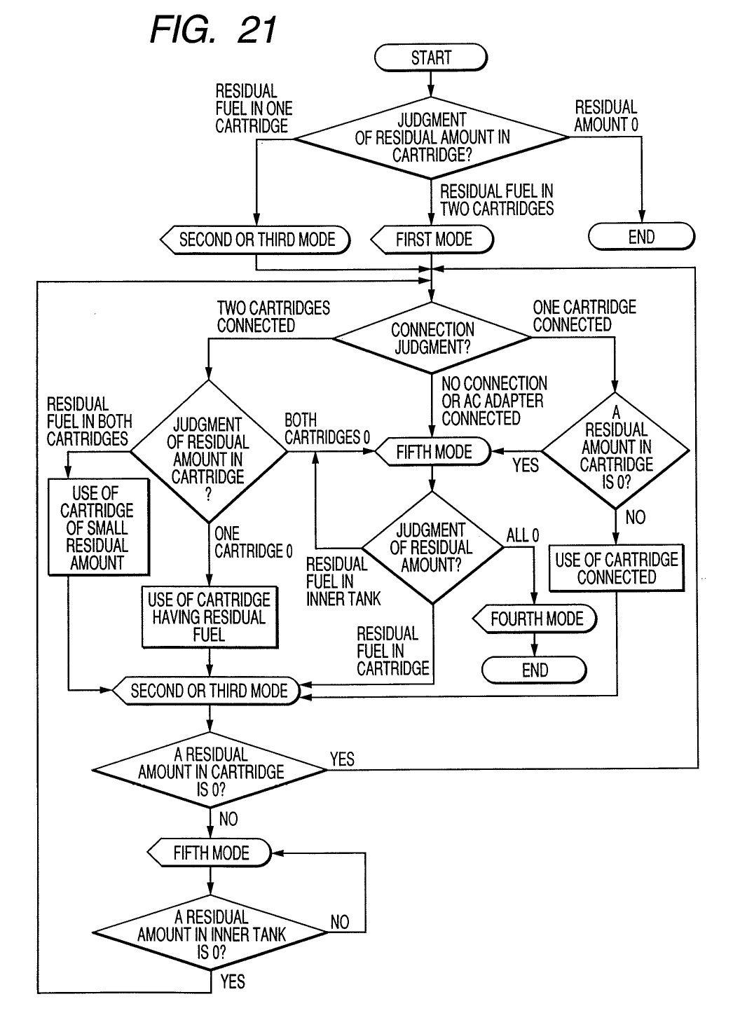

A flow chart for selectively use of the five modes is shown in FIG. 21. As shown in FIG. 21, the cartridges 10a, 10b, the internal tank 26 and the AC adapter 40 are selectively used in accordance with their connection status to use energy more effectively.

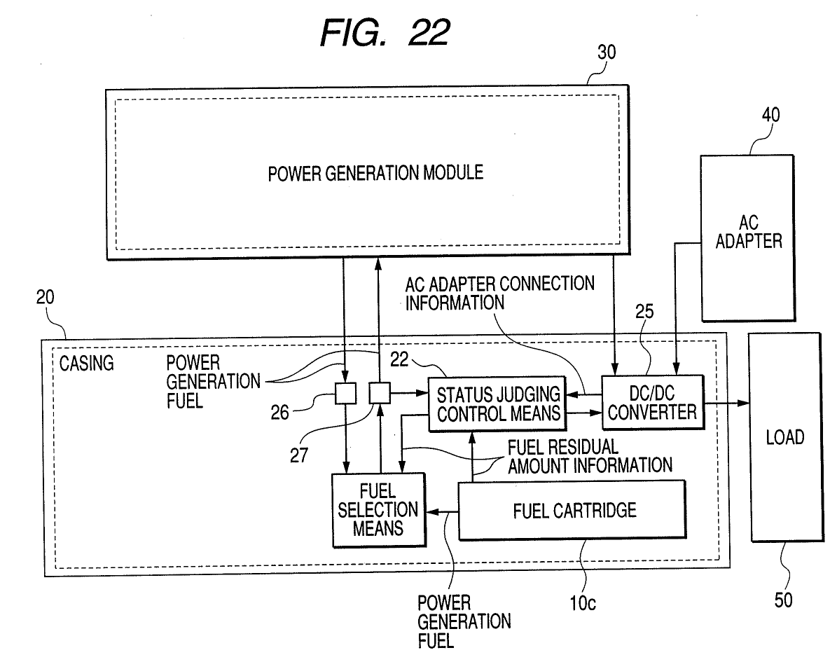

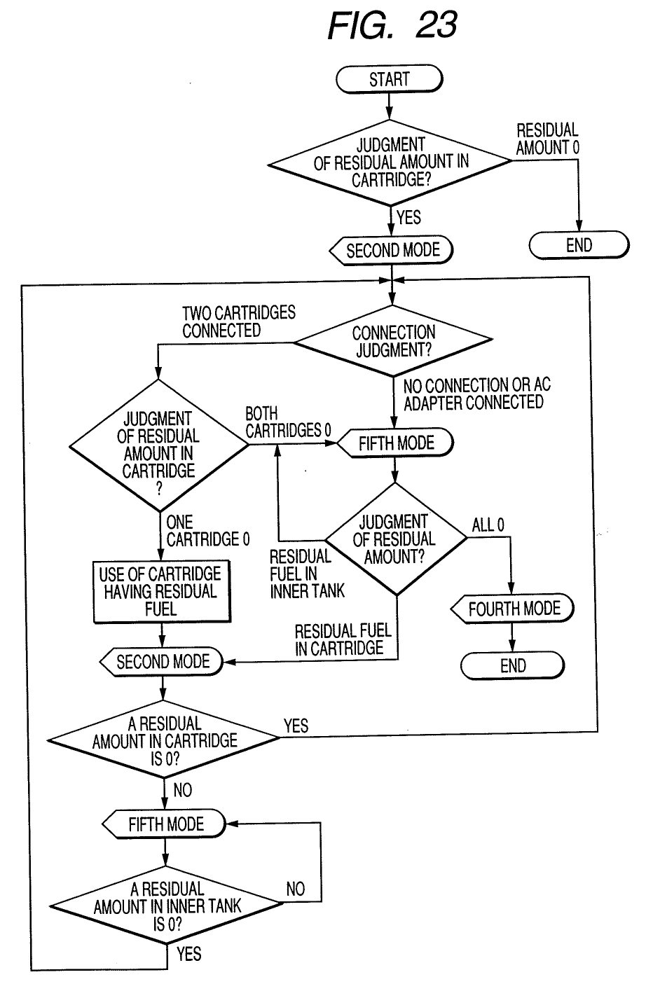

A fuel cell apparatus shown in FIG. 21 having one fuel cartridge and the internal tank 26 is explained by reference to FIGS. 22 and 23.

In FIG. 22, because one cartridge is used, the fuel selection means 21 has three modes, i.e. the second mode, fourth mode and fifth mode explained in FIG. 21.

The second mode uses fuel from the fuel cartridge 10c; the fourth mode does not use any of fuel from the cartridge 10c and returned fuel in the internal tank located in the fuel return passage from the power generation module 30; and the fifth mode circulates fuel, returned from the power generation module in the inner tank 26 located in the fuel return passage. A flow chart for the selective use of the three modes is shown in FIG. 23. The three modes have the similar functions as those explained before.

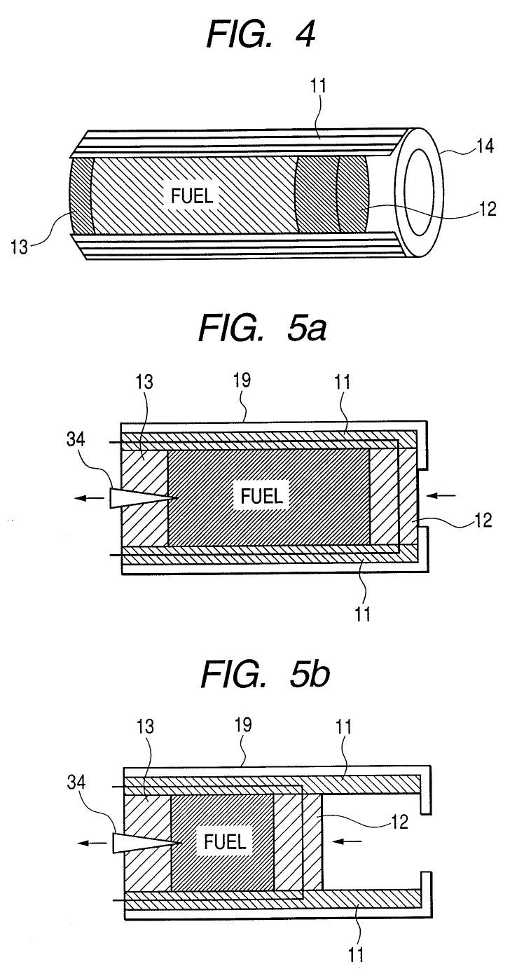

A structure of the fuel cartridge used in this example will be explained by reference to FIGS. 4 and 5. In the drawings, the left side is the fuel supply side.

The fuel cartridge 10 contains fuel in a cylinder 19; two conductive terminals 11 are separately bonded to the inner surface of the cylinder 11. A piston 12 having a conductive portion is slidably disposed in the cylinder 19. The piston slides in the axial direction and a circuit with the terminals. The two plate terminals 11 are bonded to the inner wall in a symmetric relation with respect to the axis of the cylinder 19. The wall of the cylinder 19 is made of a material having resistance to methanol, insulating and transparency, such as glass, plastic, etc.

A sealing member 13 is made of a material such as rubber, which has resistance to methanol and is capable of being pierced with a needle 34 for fuel suction. When the needle 34 is inserted into the fuel supply side seal member 13 to pierce it. The piston is always biased towards the fuel supply side by a suitable manner such as a spring (not shown). The terminals 11 are made of a material having resistance to methanol, such as stainless steel (SUS), titanium, conductive film, etc. The terminals have such a thickness and width that fuel does not leak out through the piston 12 or the fuel supply side seal 13 and that the electric resistance of the terminals is smaller by 2 orders than that of fuel.

The piston 12 is made of a conductive material such as conductive rubber so that good contact of the piston with the terminals 11 and good sealing are expected. The piston 12 may be provided with conductive terminals made of metals or conductive rubber thereby to short-circuit the terminals 11, when the piston is made of non-conductive material. The piston 12 is made of a material having resistance to methanol.

FIGS. 19a, 19b and 19c show a structure of the fuel cartridge 10a, 10b. FIG. 19a is a partially broken, perspective view of the fuel cartridge; FIG. 19b is a cross sectional view of the cartridge; and FIG. 19c is a cross sectional view along the line B-B in FIG. 10(b). O-rings 31, 32 for preventing leak of fuel are disposed to the fuel supply seal 13 and the piston 12, respectively. The piston 12 is biased by a spring 33 to confine a certain volume in the cylinder 19. The piston 12 has a short-circuit terminal 15.

FIGS. 5(a) and 5(b) show the cross sectional views of the fuel cartridges 10, 1b. The piston 12 slidably moves, making a contact with conductive terminals 11, as an amount of fuel changes. By detecting the change of electric resistance between the terminals from the fuel supply side, a residual amount of fuel in the fuel cartridge is detected. The status of the connection of the fuel cartridge is easily understood by detecting the resistance between the terminals 11.

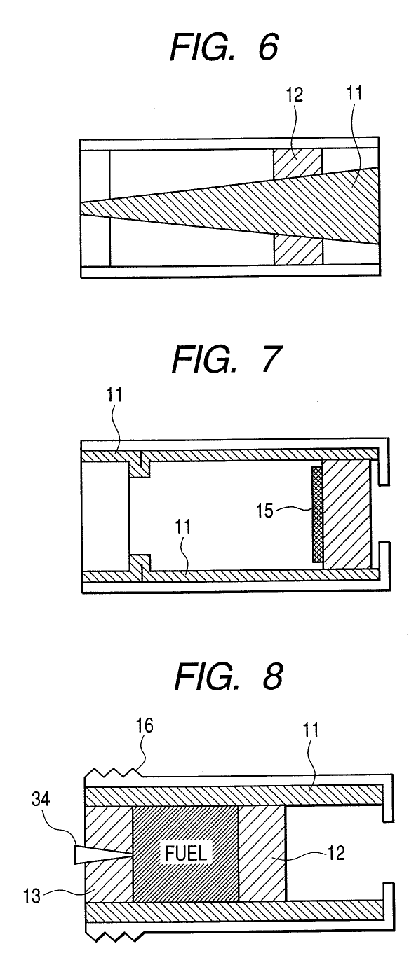

FIG. 6 shows a cross sectional view of an inner structure of the cylinder of the fuel cartridge, viewed from one of the terminals 11. The width of the conductive terminals 11 becomes smaller in the axial direction as shown in FIG. 6. That is, the width of the terminal at the fuel supply side is smaller than that at the opposite side of the fuel supply side, a higher sensitivity of detecting the residual amount of fuel is expected, as the residual amount of fuel becomes smaller.

Further, as shown in FIG. 7, when a terminal 15 having smaller resistance than the terminals 11 is added to the piston 12, zero detection of fuel becomes possible. When the residual amount of fuel becomes zero, the short-circuiting terminal 15 makes contact with a projection of the terminals 11 thereby to change its electric resistance. A zero detection terminal can be disposed in addition to the terminals 11. Since the cylinder 19 transmits light or is transparent, users can confirm the residual amount of fuel in the fuel cartridges, and furthermore, the users can know the position of the piston with eyes.

Accordingly, it is possible to know the residual amount of fuel during the use of load 50 or even during not-use of the load. Visible colors for the piston 12 may be selected in accordance with demands.

The piston 12 of the fuel cartridge can be made of insulating materials. By this structure, it is possible to detect the residual amount of fuel in the cartridge by detecting a change of electric resistance of fuel between the terminals 11 or a change of capacitance between the terminals 11. When the casing of the cartridges is made of a transparent material. Users can know the position of the piston 12 with eyes; the residual amount of fuel is confirmed during the use of appliances or during not-use of the appliances. The piston 12 may be colored with good visibility.

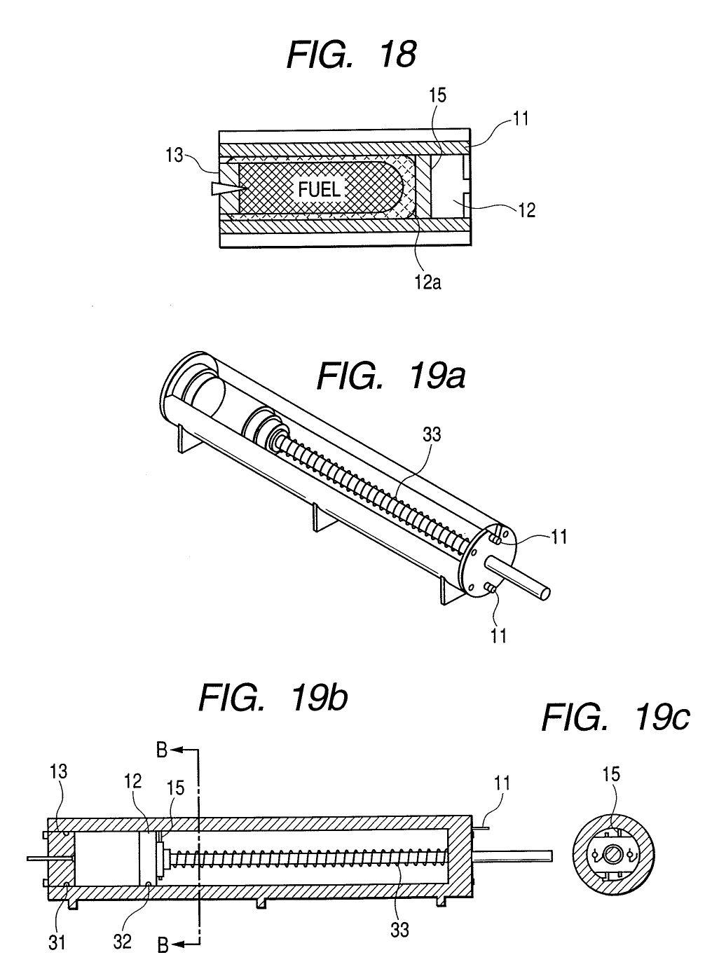

As shown in FIG. 18, fuel can be stored in an expanded elastic envelope 12a made of a material with methanol resistance, like an air balloon; the sealing port of the envelope is sealed with the fuel supply side seal member 13 having the similar properties as those explained before. The wall of the cylinder 19 is preferably made of transparent material, and two terminals 11 are bonded to the inner wall of the cylinder 19. The conductive terminals 11 should be such materials that are resistive to forming of rust due to the environment. Further, a short-circuit terminal 15 for short-circuiting between the terminals 11 that slidably moves as the shrinkage of the elastic envelope filled with fuel is disposed.

The structure of the short-circuit terminals 15 employs a spring structure, such as rubber that always makes contact with the piston or the conductive terminals 11. The automatic ejection of the fuel by shrinkage of the elastic member outside of the fuel cartridge supplies fuel to the fuel cells, and the movement of the short-circuit terminals 15 as the shrinkage of the envelope detects the residual amount of fuel in the fuel cartridge by detecting the resistance between the terminals 11. By employing the elastic envelope, fuel supply is made more effective, and the possibility of fuel leakage becomes smaller. The connection of the fuel cartridge is detected, and the detection sensitivity of residual amount of fuel is adjustable by changing the width of the terminals 11. Users can know the position of the piston 12 with eyes; the residual amount of fuel is confirmed during the use of appliances or during not-use of the appliances. The piston 12 may be colored with good visibility.

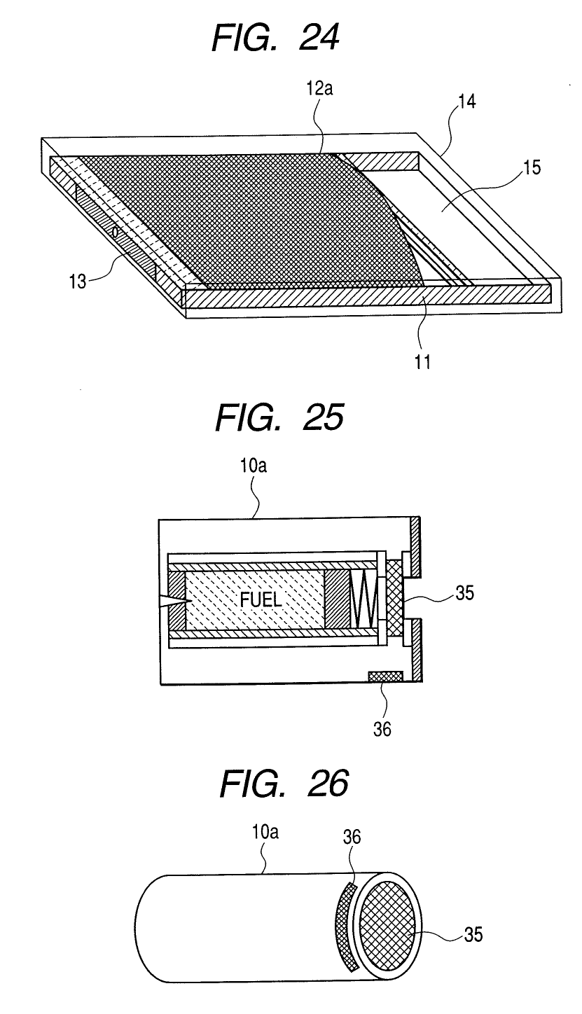

The shapes of the cartridge may be varied variously, such as a card type shown in FIG. 24, a prism, a triangle column, etc. FIG. 24 shows a perspective view of the card type cartridge, wherein the same reference numerals as in FIG. 18 mean the same member. The card type cartridge has an advantage that it needs little space for accommodation.

The short-circuit terminal of the fuel cartridge may be omitted, or the piston 12 can be made of an insulating material. By this structure, fuel is automatically supplied outside of the cartridge as the shrinkage of the envelope takes place. Since the width of the fuel in the cartridge as shown in FIG. 6 as the change of residual amount of fuel, the residual amount of fuel is detected by detecting the electrostatic capacitance between the terminals. Users can know the position of the piston 12 with eyes; the residual amount of fuel is confirmed during the use of appliances or during not-use of the appliances. The piston 12 may be colored with good visibility.

The residual amount of fuel in the cartridge is detected by detecting electro-static capacitance between the two additional terminals.

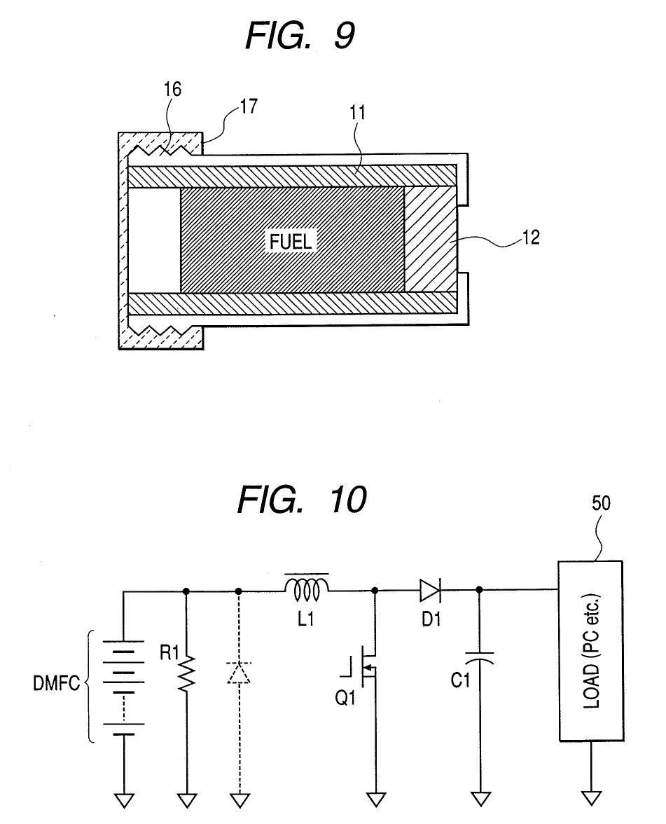

As shown in FIG. 8, a screw 16 is formed at the fuel supply port of the fuel cartridge, by which the cartridge is fitted to the casing 20 by screwing. Thus, it is possible to fasten the cartridge to the casing 20 with ease. As shown in FIG. 9, a cap 17 is disposed to the cartridge, when it is put on the market. Thus, fuel leakage from the cartridge on the market is avoided.

A filter 35 for filtering air for the cathode and a air supply port 36 at a position for supplying air to the filter are disposed to the fuel cartridge. As an example of the cartridge 10a, FIG. 25 and FIG. 26 show the structures of the cartridges. As a material for the filter 35, cotton, activated carbon, etc. may be used, but such materials that they not only adsorb dust, pollen in the air, but also adsorb substances such as sulfur or sulfur compounds that have adverse effects on the cathode of the fuel cell are preferable.

In the following, an example that employs a DC/DC converter 25 for detecting electric resistance of the cartridge to detect the residual amount of fuel in the fuel cartridge is explained.

FIG. 10 shows an example of connection between the DMFC and DC/DC converter for supplying electric power with a constant voltage to the load 50. In FIG. 10, a boosting chopper type DC/DC converter is used. By employing the boosting type DC/DC converter to stabilize voltage, the number of the DMFC cells connected in series is reduced, and the number of elements is reduced, thereby to increase mounting density.

Further, in case where other types of DMFC such as insulation type such as forward type, a multi stacked type are used, a suitable chopper such as a stepdown chopper is employed in accordance with the specification of the load 50. In the present invention, a resistor R1 having a high resistance for lowering the voltage per unit cell of DMFC to 1 volt or less is connected to the terminal of the DMFC, as shown in figure.

Further, as a substitute for the resistor R1, a constant voltage diode (shown by a dotted line) may be connected. By these voltage suppression, the voltage of the unit cell is controlled to 1 volt or less so that deposition of catalyst of DNFC is avoided because the maximum voltage of the unit cell becomes 1 volt or lower, and a DC/DC converter with elements having a relatively lower rated voltage can be used because the maximum output voltage of the DMFC becomes lower. Similarly, since the maximum voltage of DMFC becomes lower, the number of capacitors such as electric double layer condensers in series connection can be reduced.

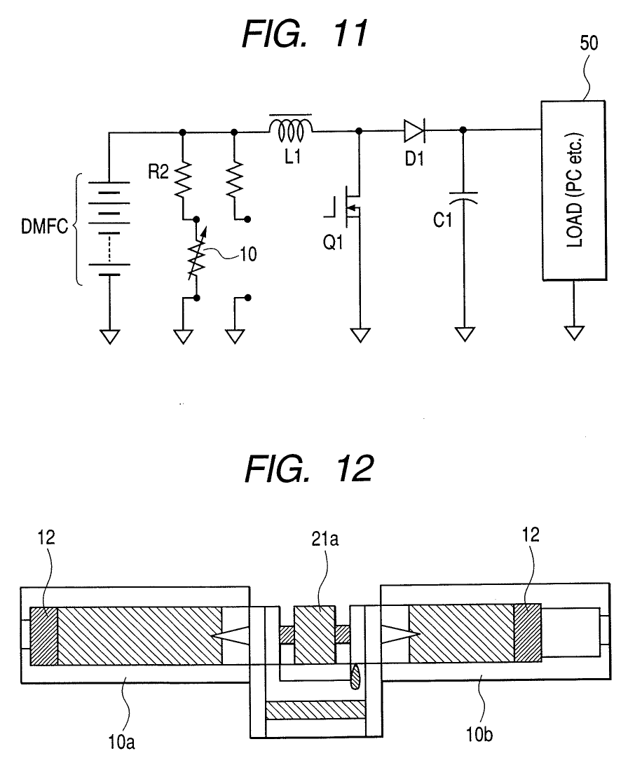

An example of detecting the residual amount of fuel in the fuel cartridge of resistance detection type is shown in FIG. 11, wherein a fuel cartridge 10 is connected to the output terminal of the DMFC as a substitute for the resistor. As shown in FIG. 11, the resistor R2 is connected in series with the cartridge so that the maximum voltage applied to the cartridge is 1.2V or less. As a result, the cartridge connection voltage becomes 1.2V or less when the fuel cartridge 10 is connected; and when the fuel cartridge 10 is not connected, the cartridge connection terminal voltage is the output voltage (1.2V or more) of DMFC. Thus, detection of connection is easy. When a voltage applied to the fuel cartridge 10 is detected by an A/D port, etc., the detection of a residual amount of fuel in the cartridge 10 and detection of the fuel cartridge are possible, and furthermore, selective use of the fuel cartridges becomes possible in accordance with the detected values.

A second example of detecting the residual amount of fuel in the fuel cartridge employs a system wherein a resistor is connected to the output terminal of the DC/DC converter. The resistor is connected with the cartridge in series so that the maximum voltage applied to the cartridge is 1.2V or less. By connecting the resistor to the output terminal of the DC/DC converter, the voltage applied to the fuel cartridge is suppressed. When the resister is connected to a terminal of a load such as a notebook type personal computer, thereby to send information concerning the residual amount of fuel to the load.

An example for selecting fuel cartridges employs a step motor 21a between the fuel cartridge 10a and fuel cartridge 10b to select flow passages of fuel. Further, there are other systems such as a system using an electromagnetic vane for closing—opening passages, a system selectively using pumps for fuel supply.

Although, in the systems using the step motor and electromagnetic vane, a power for supplying fuel outside of the fuel cartridge is necessary, this power may be given a spring disposed to the casing to eject fuel. Further, there is another system using shrinkage power of elastic member, as shown in FIG. 18. A spring may be disposed as an auxiliary power source. The fuel cartridge may include a magnetic member in the piston 12 of the fuel cartridge and a magnet is disposed near the fuel suction port.

### Example 2

Instead of the disposable cartridge, a reusable and rechargeable fuel tank can be used. This structure will be explained in the following.

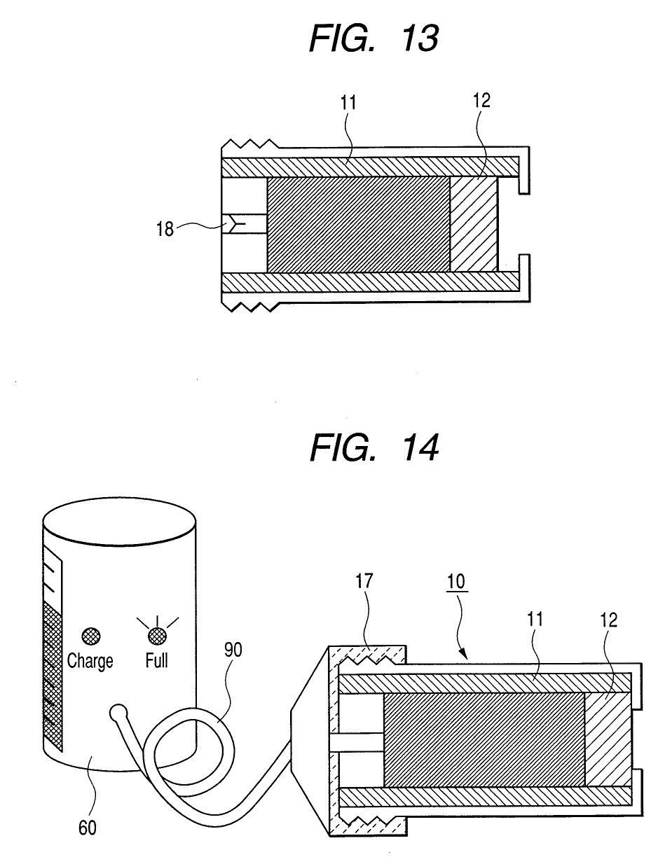

In this example, the fuel tank has a check valve 18 and the fuel supply side seal member 13 is disposed, as shown in FIG. 13. The check valve can supply fuel only when the seal is disposed.

Re-filling of fuel in the fuel tank will be explained by reference to figures.

A first re-filing method includes a step of dismounting the fuel tank, followed by re-filling fuel. As shown in FIG. 14, fuel is re-filled in the fuel tank under pressure using a charger 60. The fuel cartridge 10 is communicated with a fuel charger 60 by means of a hose 90. The charger 60 has a transparent portion through which the supplemental fuel is seen. During re-filling of fuel, operation conditions such as end of refilling are indicated by an LED. The condition of full re-filling of the fuel tank is detected by a pressure sensor at the side of the charger 60 or a signal from the residual amount of fuel. Then, the re-filling fuel or supplement of fuel can be ended.

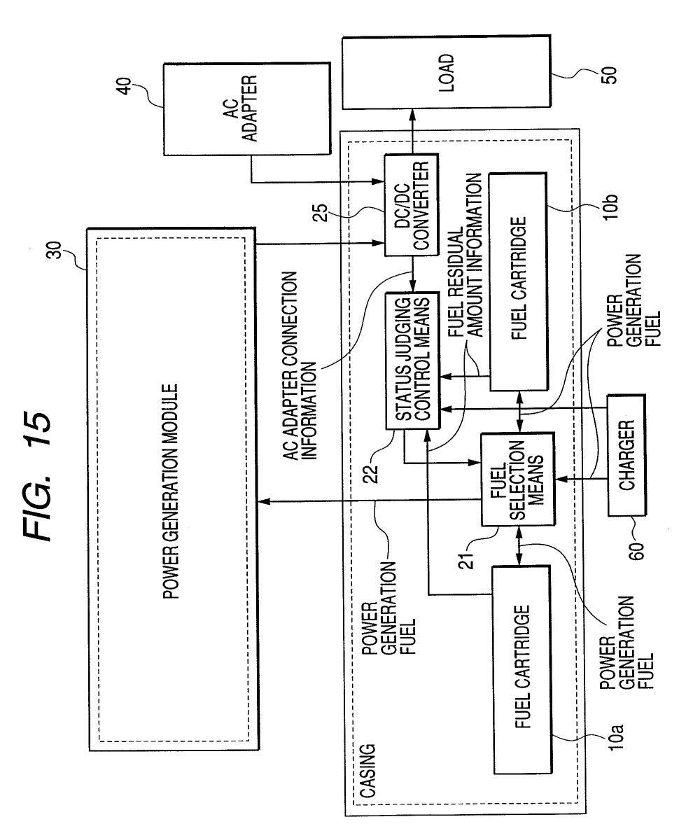

A second method of re-filling fuel employs the charger 60 disposed in the casing. The arrangement of this system is shown in FIG. 15. In addition to the four fuel supply modes in example 1, a fuel charge mode is added, wherein connection of the charger 60 is detected, whereby a passage from the charger 60 to the fuel tank is connected. As same as the first example of re-filling method, the full supplement to the fuel tank is detected by at least one of a pressure sensor or the residual amount of fuel in the fuel tank, and then supplement is ended.

The charger 60 is provided with a connector and a power supply terminal to supply power to the load 50. Further, in addition to the passage directly connected to the fuel tank, there is disposed a passage connected to the power generation section. It is possible to improve safety of load driving during the re-filling of the fuel tanks using at least one of the above structures.

A system may have the two functions mentioned above, one of which is selected by a user on demand.

### Example 3

An example that has a cleaning function of the power generation section in addition to the functions of examples 1 and 2 is explained in the following.

In the apparatus explained in example 1, the power generation section is cleaned with a cleaner connected to the fuel cartridges 10, 10b and terminals of the AC adapter 40. Cleaning liquid such as pure water is injected into the power generation section from one of the fuel cartridges and waste liquid is recovered by the other cartridge. Power supply during cleaning operation is conducted by the AC adapter 40.

In the apparatus explained in example 2, the cleaner is connected to the connecting portion of the charger 60 in FIG. 15. As same as in example 1, cleaning liquid such as pure water is injected into the power generation section and waste liquid is recovered. Power supply during cleaning is conducted by means of the charger 60 or the AC adapter 40.

In the apparatus in example 3, the power generation section 30 is separated from the casing 20, and is directly connected to the cleaner. Cleaning liquid such as pure water is injected into the power generation section from the fuel supply port, and waste liquid is recovered.

In the apparatus in example 1, the connecting portion of the charger 60, which works as a connecting portion for the cleaner may be disposed.

### Example 4

The load 50 may be a robot having a human or animal type foot mechanism or a human or animal type walking mechanism, which is such a device that its gravity center always moves. The fuel cell apparatus that is combined with the robot will be explained in the following.

The fuel cartridges in example 1 are very useful for preventing malfunction due to inclination of the apparatus, which is applied to the robot having the foot mechanism. However, in case where the device has two or more fuel cartridges, fuel in a cartridge whose residual amount is larger than the other is selected in order to avoid large imbalance of gravity center. The device has the fuel selection means in addition to the selection means in example 1. Since the weight of the fuel storage section changes, being different from the conventional secondary batteries, the information of fuel residual amount is used not only for an operation plan, such as calculation of an operation time of the device, but also for calculation of ZMP (zero moment point) by calculation of the weight of the fuel storage section based on the fuel residual amount information. According to this example, the weight imbalance is prevented.

### Example 5

Another example other than electronic appliances is explained. The load 50 having the fuel cell apparatus is a vacuum cleaner, which needs a directional freedom upon commands by a user.

When the fuel cell apparatus is applied to the vacuum cleaner, the fuel cell cartridge in example 1 is very useful so as to secure the directional freedom. Particularly, the cartridge is applicable to hand-carrying vacuum cleaners that need a higher directional freedom. In this example, the cartridges shown in FIGS. 25 and 26 can be used as filters for exhaust air.

It is possible to provide a light-weighted fuel cell apparatus with directional freedom in use, and the fuel cell apparatus disposed in an appliance can be exchanged with another fuel cell apparatus.

1-2. (canceled)

3. The fuel cell apparatus according to claim 1, wherein each of the fuel storage sections has a fuel residual amount detection means, and wherein the fuel storage section having the smallest residual fuel amount is selected to generate electric power, while the fuel cell apparatus is in service.

4. The fuel cell apparatus according to claim 1, which further comprises a casing for holding the fuel storage section, and a power generation module which is capable of mounting to and dismounting from the fuel cell apparatus.

5-6. (canceled)

7. The method of controlling the fuel cell apparatus according to claim 21, which comprises a first mode using fuel in all of the fuel storage sections, a second mode using fuel in one of the two fuel storage sections, a third mode using fuel in the other fuel storage sections, and a fourth mode using fuel in none of the two fuel storage sections.

8. A fuel cell generator according to claim 20, wherein two conducting portions having electric resistance and conducive connecting portions connected to the conducting portions are disposed to each of the fuel cartridges, the conductive connecting portions being moved in accordance with an amount of residual fuel between the two conducting portions, and wherein at least one of electric resistance and electrostatic capacitance between the two conducting portions is detected to detect the amount of residual fuel in the fuel cartridges.

9. (canceled)

10. The fuel cell apparatus according to claim 8, wherein the conductive connecting portions have such resistance that the voltage per one cell of the fuel cell is set to 1.0V or less.

11. The fuel cell apparatus according to claim 8, wherein the fuel storage sections are of cylindrical cartridge type and the conductive connecting portions are of piston type, each of the fuel storage sections comprising a seal member for sealing the fuel supply side.

12. The fuel cell apparatus according to claim 11, wherein the conducting portions are plates adhered to inner surfaces of the fuel storage sections, and wherein the widths of the conductive portion in the moving direction of the conductive connecting portions is larger than that of the sealing portion.

13. The fuel cell apparatus according to claim 11, which further comprises a screw disposed to at least one end of each of the fuel storage sections.

14. The fuel cell apparatus according to claim 11, wherein the fuel storage sections are made of material having transmittance to light.

15. The fuel cell apparatus according to claim 8, wherein each of the fuel storage sections has a seal member for encasing an elastic envelope and the fuel supply side, whereby fuel is stored in the envelope by expanding it.

16. The fuel cell apparatus according to claim 21, wherein the amounts of residual fuel in the fuel storage sections are detected to calculate weights of the fuel, the calculated weights being used to compute weight balance between the fuel storage sections.

17. The fuel cell apparatus according to claim 21, wherein the residual fuel in the fuel storage sections is withdrawn and liquid for cleaning the fuel storage section is supplied into the fuel storage sections.

18-19. (canceled)

20. A fuel cell generator comprising at least two fuel cartridges each containing methanol, a power generation module and a control means, wherein the power generation module is connectable to the fuel cartridges and the control means, the power generation module is connectable to an electronic device by means of a DC/DC converter in the control means, the power generation module comprises a direct methanol fuel cell, the DC/DC converter being provided for connecting the power generation module to the electronic device, and wherein the control means comprises a first means for judging a status of the at least one of the fuel cartridges in accordance with a residual amount of methanol in at least one of the fuel cartridges, and a second means for selecting one of the fuel cartridges in response to the signals representing the status of the fuel cartridges from the first means, and wherein the fuel cartridges each has a member, which is biased towards a fuel supply side in the fuel cartridges to supply the methanol to the direct methanol fuel cell.

21. A method of controlling a fuel cell power generator, which comprises:
connecting at least two fuel cartridges containing methanol to a control means, wherein the fuel cartridges each has a resilient member, which is biased towards a fuel supply side in the fuel cartridges to supply the methanol to a direct methanol fuel cell;
detecting a status of one of the fuel cartridges; and
selecting one of the fuel cartridges to supply the fuel solution to the direct methanol fuel cell in accordance with the signals from the status of the fuel cartridges, wherein the methanol is supplied from the selected fuel cartridge to the direct methanol fuel cell by the action of the biased member in the cartridges.

22. In a fuel cell generator comprising a direct methanol fuel cell, a fuel cartridge containing a methanol solution, a power generation module and a control means, wherein the power generation module is connectable to the fuel cartridge and the control means, and the power generation module is connectable to an electronic device by means of a DC/DC converter in the control means, the improvement which comprises a member, which is disposed to the fuel cartridge and is biased towards a supply side to supply the methanol to the direct methanol fuel cell.
